(19) United States
(12) Patent Application Publication
(10) Pub. No.: US 2007/0147622 A1
(43) Pub. Date: Jun. 28, 2007

(54) Audio apparatus

(75) Inventor: Takashi Ohki, Kyoto (JP)

Correspondence Address: ROHM CO., LTD.;C/O KEATING & BENNETT, LLP, 8180 GREENSBORO DRIVE, SUITE 850, MCLEAN, VA, 22102, US

(73) Assignee: ROHM CO., LTD., Ukyo-ku, Kyoto (JP)

(21) Appl. No.: 10/596,765

(22) PCT Filed: Dec. 27, 2004
(86) PCT No.: PCT/JP04/19505

§ 371 Date: Jun. 23, 2006

(30) Foreign Application Priority Data
Dec. 25, 2003 (JP) 2003-431607

(51) Int. Cl. H04R 5/00; H04R 5/02

(52) U.S. Cl. 381/18; 381/19; 381/307

(57) ABSTRACT

An audio apparatus, which is compatible with multi-channel audio sources, is capable of achieving reproduction without sound drop-out even in use with only two speakers. The audio apparatus includes an audio mixing circuit that inputs an L audio signal, R audio signal, C audio signal, SL audio signal, SR audio signal and SW audio signal, respectively mixes the C audio signal, SL audio signal, SW audio signal with the L audio signal in a predetermined ratio and mixes the C audio signal, SR audio signal, SW audio signal with the R audio signal in a predetermined ratio; and an audio signal conditioning circuit that inputs the output signal of the audio mixing circuit and adjusts the signal waveform thereof.

### BACKGROUND OF THE INVENTION

1. Field of the Invention

The present invention relates to an audio apparatus compatible with multi-channel audio sources.

2. Description of the Related Art

In recent years, an audio apparatus compatible with multi-channel (for example, so-called 5.1 channel) audio sources used in, for example, a home theatre has been commercialized. Such an audio apparatus makes it possible to obtain an effect like that of a theatre or concert hall by arranging speakers on the left and right and centrally in front of the audience and on the left and right to the rear of the audience (see, for example, Laid-open Japanese Patent Application No. 2002-345097). A 5.1 channel audio apparatus, like the conventional stereo audio apparatus, processes stereo audio signals including an audio signal of a left channel (L) for the front left-hand speaker and an audio signal of a right channel (R) for the front right-hand speaker with respect to the audience. In addition, such a 5.1 apparatus processes surround audio signals including an audio signal of the center channel (C) for the speaker at the front in the middle, an audio signal of the surround left channel (SL) for the speaker to the rear on the left-hand side, an audio signal of the surround right channel (SR) for the speaker to the rear on the right-hand side and an audio signal of a sub-woofer channel (SW) for a speaker that outputs in deep bass audio bands (for example, bass guitar or drum sounds). Audio sources corresponding to the performed content are assigned to these respective channels. Also, in a DVD optical disc, the audio sources of these multiple channels are recorded and, typically, the audio apparatus for these multiple channels performs reproduction thereof.

The block diagram of FIG. 4 shows the output section of a conventional audio apparatus compatible with 5.1 channel audio sources. This audio apparatus 101 includes an audio signal conditioning circuit 103, power amplifiers 104L, 104R, 104C, 104SL, 104SR, 104SW, speakers 105L, 105R, 105C, 105SL, 105SR and 105SW. The audio signal conditioning circuit 103 inputs the L audio signal, R audio signal, C audio signal, SL audio signal, SR audio signal, and SW audio signal respectively from the input terminals L, R, C, SL, SR and SW into the LinA terminal, RinA terminal, CinA terminal, SLinA terminal, SRinA terminal and SWinA terminal of the audio signal conditioning circuit 103. Adjustment of the waveform of the audio signals, i.e., adjustment of for example the quantity of sound, treble and bass is then performed and the signals are then respectively output from the LoutA terminal, RoutA terminal, CoutA terminal, SLoutA terminal, SRoutA terminal and SWoutA terminal of the audio signal conditioning circuit 103.

Power amplifiers 104L, 104R, 104C, 104SL, 104SR and 104SW then input the respective audio signals from the LoutA terminal, RoutA terminal, CoutA terminal, SLoutA terminal, SRoutA terminal and SWoutA terminal of the audio signal conditioning circuit 103 and thereby drive the speakers 105L, 105R, 105C, 105SL, 105SR, and 105SW.

In this way, with an audio apparatus having multi-channel audio sources, the audience can enjoy an effect like that of a theatre or concert hall. However, depending on the environment of use of this audio apparatus (such as, for example, the size of the room), speakers could sometimes only be arranged in front of and to left and right of an audience in the same way (in the case of a stereo set) as in the case of a conventional stereo audio apparatus, without providing a very large number of speakers. In this case, as shown in FIG. 5, only the LoutA terminal and RoutA terminal of the audio signal conditioning circuit 103 are connected with the power amplifiers 104L, 104R, and stereo audio signals including an L audio signal and R audio signal from the speakers 105L and 105R are thereby converted to sound, and then output.

Consequently, the audio signals of the CoutA terminal, SLoutA terminal, SRoutA terminal and SWoutA terminal of the audio signal conditioning circuit 103 are not output from the speakers, so the sound that is assigned to the C audio signal, SL audio signal, SR audio signal and SW audio signal drops out and cannot be heard by the audience.

### SUMMARY OF THE INVENTION

In order to overcome the problems described above, preferred embodiments of the present invention provide an audio apparatus wherein reproduction of multi-channel audio sources can be achieved without drop-out, both for multi-channel audio sources where a speaker is connected to each audio source and where the number of connected speakers is less than the number of audio sources.

An audio apparatus according to a preferred embodiment of the present invention includes an audio mixing circuit that inputs a left channel audio signal, a right channel audio signal, a center channel audio signal, a surround left channel audio signal, a surround right channel audio signal and a sub-woofer channel audio signal and that is capable of delivering output by respectively mixing a center channel audio signal, a surround left channel audio signal, and a sub-woofer channel audio signal with a left channel audio signal in a predetermined ratio, a center channel audio signal, a surround right channel audio signal, and a sub-woofer channel audio signal with a right channel audio signal in a predetermined ratio; an audio signal conditioning circuit that inputs the output signal of the audio mixing circuit and adjusts the signal waveforms; a power amplifier section including a plurality of power amplifiers that amplify audio signals whose signal waveform has been adjusted; and a speaker section including a plurality of speakers driven by the amplified audio signals.

Preferably, the audio mixing circuit of this audio apparatus is capable of selecting one of a condition in which output is delivered after mixing and a condition in which output is delivered without mixing the left channel audio signal, right channel audio signal, center channel audio signal, surround left channel audio signal, surround right channel audio signal and sub-woofer channel audio signal.

With the audio apparatus according to preferred embodiments of the present invention, since the audio mixing circuit is provided, even if a speaker is connected with each audio source or even if, for example, only two speakers are connected such that the number of connected speakers is less than the number of audio sources, reproduction can be achieved without dropping out of the audio sources of the multiple channels, making it possible to enjoy an effect like that of a theatre or concert hall.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a block diagram of a full set of an audio apparatus according to a preferred embodiment of the present invention.

FIG. 2 is a block diagram of a stereo set of an audio apparatus according to a preferred embodiment of the present invention.

FIG. 3 is a circuit diagram of an audio mixing circuit according to a preferred embodiment of the present invention.

FIG. 4 is a block diagram of a full set of an audio apparatus according to the background art.

FIG. 5 is a block diagram of a stereo set of audio apparatus according to the background art.

### DETAILED DESCRIPTION OF PREFERRED EMBODIMENTS

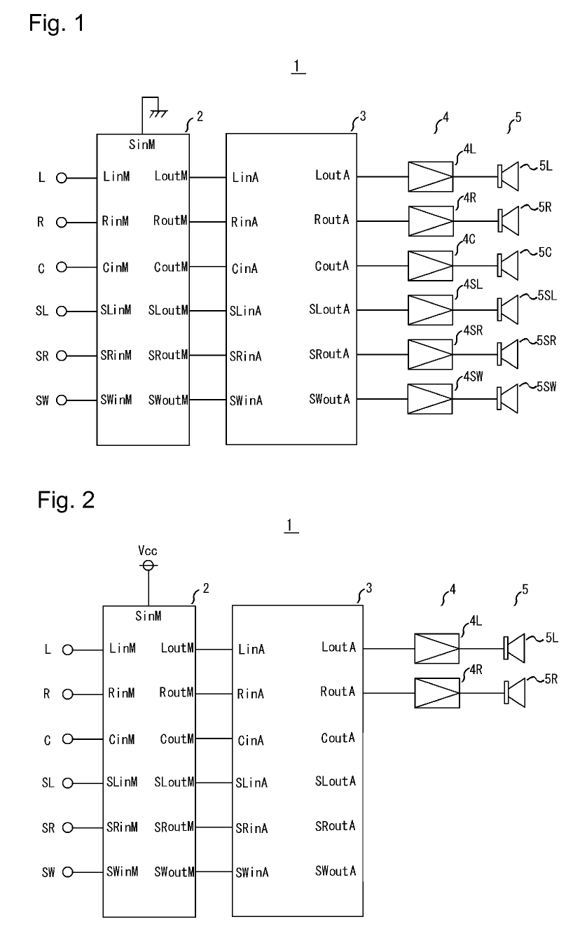

Preferred embodiments of the present invention will now be described with reference to the drawings. FIG. 1 and FIG. 2 are block diagrams of an audio apparatus 1 compatible with multi-channel audio sources according to a preferred embodiment of the present invention. This audio apparatus 1 is preferably 5.1 channel audio apparatus. One of the unique features of the audio apparatus 1 is that an audio mixing circuit 2 is arranged upstream of the audio signal conditioning circuit 3. The audio signal conditioning circuit 3 is a circuit that is preferably substantially the same as the audio signal conditioning circuit 103.

Specifically, in the case of a full set (home theatre set) shown in FIG. 1, this audio apparatus 1 includes an audio mixing circuit 2, audio signal conditioning circuit 3, power amplifier section 4, more specifically, power amplifiers 4L, 4R, 4C, 4SL, 4SR, 4SW and a speaker section 5, more specifically, speakers 5L, 5R, 5C, 5SL, 5SR and 5SW. On the other hand, in the case of a stereo set shown in FIG. 2, the audio apparatus 1 includes an audio mixing circuit 2, an audio signal conditioning circuit 3, a power amplification section 4 including power amplifiers 4L, 4R, and a speaker section 5 including speakers 5L and 5R.

In this audio mixing circuit 2, a stereo audio signal including a left channel (L) audio signal and right channel (R) audio signal is input from the respective input terminals L, R to the LinM terminal and RinM terminal; and a surround audio signal including a center channel (C) audio signal, surround left channel (SL) audio signal, surround right channel (SR) audio signal and sub-woofer channel (SW) audio signal is input from the respective input terminals C, SL, SR, SW to the CinM terminal, SLinM terminal, SRinM terminal and SWinM terminal. Processing of the stereo audio signal and surround audio signal is controlled by the mixing control circuit 20, described in detail below. This mixing control circuit 20 has an SinM terminal as input terminal, and has an inversion output terminal and non-inversion output terminal. Changeover is effected between the condition in which the SinM terminal is grounded and the condition in which the SinM terminal is connected to the power source Vcc, via an external changeover switch (not shown).

First of all, in the case of a full set, as shown in FIG. 1, the audio mixing circuit 2 is arranged such that the SinM terminal, i.e. the input terminal of the mixing control circuit 20, is grounded. In this way, the audio signals that are input to the LinM terminal, RinM terminal, CinM terminal, SLinM terminal, SRinM terminal and SWinM terminal are respectively directly output from the LoutM terminal, RoutM terminal, CoutM terminal, SLoutM terminal, SRoutM terminal and SWoutM terminal.

The audio signal conditioning circuit 3 performs the adjustment of the waveform, i.e. the adjustment of, for example, the amount of sound, treble and bass, of the audio signals that are input from the LoutM terminal, RoutM terminal, CoutM terminal, SLoutM terminal, SRoutM terminal and SWoutM terminal of the audio mixing circuit 2 into the respective LinA terminal, RinA terminal, CinA terminal, SLinA terminal, SRinA terminal and SWinA terminal, and respectively outputs these audio signals on which waveform adjustment has been performed from the LoutA terminal, RoutA terminal, CoutA terminal, SLoutA terminal, SRoutA terminal and SWoutA terminal.

The power amplifiers 4L, 4R, 4C, 4SL, 4SR, 4SW of the power amplifier section 4 input the audio signals that have respectively been adjusted in waveform from the LoutA terminal, RoutA terminal, CoutA terminal, SLoutA terminal, SRoutA terminal and SWoutA terminal of the audio signal conditioning circuit 3 and amplify these, and drive the speakers 5L, 5R, 5C, 5SL, 5SR and 5SW of the speaker section 5 via the amplified audio signals.

In contrast, in the case of a stereo set, as shown in FIG. 2, the SinM terminal, i.e., the input terminal of the mixing circuit 20 is connected with the power source Vcc. In this way, the audio signals that are input to the CinM terminal, SLinM terminal and SWinM terminal are mixed with the audio signal that is input to the LinM terminal, the audio signals that are input to the CinM terminal, SRinM terminal and SWinM terminal are mixed with the audio signal that is input to the RinM terminal, and are output as a stereo audio signal from the LoutM terminal and RoutM terminal. Audio signals from the CoutM terminal, SLoutM terminal, SRoutM terminal and SWoutM terminal are not output (the outputs are in a no-signal condition).

The audio signal conditioning circuit 3 performs adjustment of the waveform of the audio signals that are input to the respective LinA terminal and RinA terminal from the LoutM terminal and RoutM terminal of the audio mixing circuit 2, and respectively outputs these audio signals whose waveforms have been adjusted from the LoutA terminal and RoutA terminal. Also, in the case of a stereo set too, just as in the case of a full set, the CinA terminal, SLinA terminal, SRinA terminal and SWinA terminal of the audio signal conditioning circuit 3 are respectively connected with the CoutM terminal, SLoutM terminal, SRoutM terminal and SWoutM terminal of the audio mixing circuit 2.

Also, the power amplifiers 4L, 4R of the power amplification section 4 input and amplify the audio signals that have been respectively subjected to waveform adjustment from the LoutA terminal and RoutA terminal of the audio signal conditioning circuit 3 and the speakers 5L and 5R of the speaker section 5 are driven by the amplified audio signal. The CoutA terminal, SLoutA terminal, SRoutA terminal and SWoutA terminal of this audio signal conditioning circuit 3 are not connected to anything.

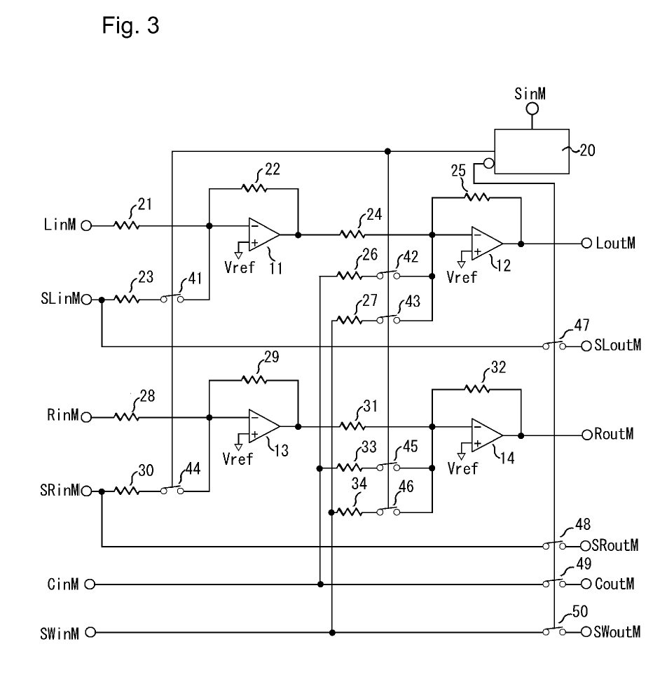

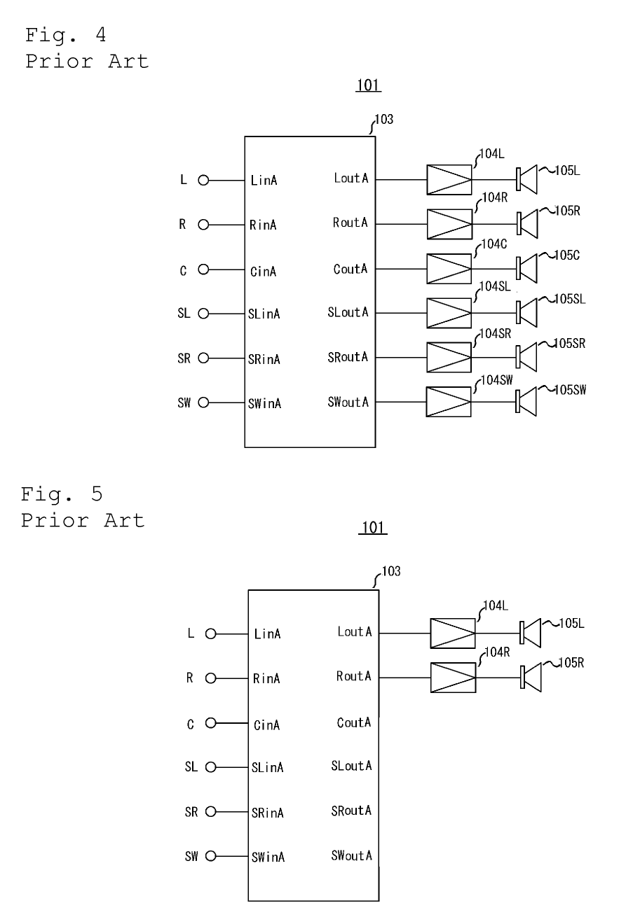

Next, the internal circuitry of the audio mixing circuit 2 will be described with reference to FIG. 3.

One end of the resistor 21 is connected with the LinM terminal and one end of the resistor 23 is connected with the SLinM terminal and one terminal of the switch 47 is connected therewith. The control terminal of the switch 47, like the control terminals of the respective switches 48 to 50, to be described later, is connected with the inversion output terminal of the mixing control circuit 20. The other terminal of the switch 47 is connected with the SLoutM terminal. The other end of the resistor 23 is connected with one terminal of the switch 41. The control terminal of the switch 41, like the control terminals of the respective switches 42 to 46, to be described later, is connected with the non-inversion output terminal of the mixing control circuit 20. The other terminal of the switch 41 and the other end of the resistor 21 are mutually connected and connected to the one end of the resistor 22 and the inversion input terminal of an operational amplifier 11. The non-inversion input terminal of the operational amplifier 11, like the non-inversion input terminal of the operational amplifiers 12 to 14, to be described later, is connected with a reference voltage Vref. The output terminal of the operational amplifier 11 and the other end of the resistor 22 are mutually connected and connected with one end of the resistor 24. Also, one end of the resistor 26 and one end of the resistor 33 are connected with the CinM terminal and connected with one terminal of the switch 49. The other terminal of the switch 49 is connected with the CoutM terminal. The other end of the resistor 26 is connected with one terminal of the switch 42 and the other end of the resistor 33 is connected with one terminal of the switch 45. One end of the resistor 27 and one end of the resistor 34 are connected with the SwinM terminal and connected with one terminal of the switch 50. The other terminal of the switch 50 is connected with the SWoutM terminal. The other end of the resistor 27 is connected with one terminal of the switch 43 and the other end of the resistor 34 is connected with one terminal of the switch 46. Also, the other end of the resistor 24 and the other terminals of the respective switches 42 and 43 are mutually connected and connected with one end of the resistor 25 and with the inversion input terminal of the operational amplifier 12. The output terminal of the operation amplifier 12 and the other end of the resistor 25 are mutually connected and connected with the LoutM terminal. The resistors 21 and 22 and resistors 24 and 25 are set to respectively equal resistances.

One end of the resistor 28 is connected with the RinM terminal and one end of the resistor 30 is connected with the SRinM terminal and with one terminal of the switch 48. The other terminal of the switch 48 is connected with the SRoutM terminal. The other end of the resistor 30 is connected with one terminal of the switch 44. The other terminal of the switch 44 and the other end of the resistor 28 are mutually connected and connected with one end of the resistor 29 and the inversion input terminal of the operational amplifier 13. The output terminal of the operational amplifier 13 and the other end of the resistor 29 are mutually connected and connected with one end of the resistor 31. The other end of the resistor 31 and the respective other terminals of the switches 45 and 46 are mutually connected and connected with one end of the resistor 32 and the inversion input terminal of the operational amplifier 14. The output terminal of the operational amplifier 14 and the other end of the resistor 32 are mutually connected and connected with the RoutM terminal. The resistors 28 and 29 are set to and resistors 31 and 32 are set to respectively equal resistances.

Next, the operation will be described. First of all, in the case of a full set, the SinM terminal is grounded, so low level is output from the non-inversion output terminal of the mixing control circuit 20 and high-level is output from the inversion output terminal. Consequently, the switches 41 to 46 do not conduct, but the switches 47 to 50 do conduct. Consequently, the audio signal that is input to the LinM terminal is inverted by the inversion amplifier constituted by the resistors 21 and 22 and operational amplifier 11, and is further inverted by the inversion amplifier constituted by the resistors 24 and 25 and the operational amplifier 12. Since the resistors 21 and 22 and the resistors 24 and 25 are set to respectively equal resistances, the audio signal that is output from the LoutM terminal is substantially equal to the audio signal that is input to the LinM terminal. Likewise, the audio signal that is output from the RoutM terminal is substantially equal to the audio signal that is input to the RinM terminal. Also, the audio signals that are input to the CinM terminal, SLinM terminal, SRinM terminal and SWinM terminal are output through the switches 47 to 50 to the CoutM terminal, SLoutM terminal, SRoutM terminal and SWoutM terminal.

In contrast, in the case of a stereo set, the SinM terminal is connected with the power source Vcc, so high level is output from the non-inversion output terminal of the mixing control circuit 20 and low level is output from the inversion output terminal. Consequently, the switches 41 to 46 conduct, but the switches 47 to 50 do not conduct. Consequently, the audio signal that is input to the LinM terminal is mixed with the audio signal that is input to the SLinM terminal in a predetermined ratio determined by the resistor 23 and is inverted and this inverted signal is mixed with the audio signals that are input to the CinM terminal and the SwinM terminal in respective predetermined ratios determined by the resistors 26 and 27 and is further inverted before being output from the LoutM terminal. Likewise, the audio signal that is input to the RinM terminal is mixed in predetermined ratios with the audio signals that are input at the SRinM terminal, CinM terminal and SWinM terminal, before being output from the RoutM terminal. Also, since the switches 47 to 50 do not conduct, the outputs of the CoutM terminal, SLoutM terminal, SRoutM terminal and SWoutM terminal are in a no-signal condition.

As described above, in the case of a full set shown in FIG. 1, by arranging speakers at each audio source, specifically, at the left and right and at the center at the front, and at the left and right at the rear, the audience can enjoy sound with the characteristic effects specific to multi-channel audio sources, and, in the case of a stereo set shown in FIG. 2, by arranging two speakers, for example, only on the left and right at the front, the audience can enjoy sound in which no audio sources of the multiple channels are lost.

It should be noted that the audio mixing circuit 2 is not restricted to that of the above-described preferred embodiments but could be implemented by other circuits. Also, the changeover switch that changes over connections of the SinM terminal of the mixing control circuit 20 with the ground or the power source Vcc may be arranged to effect changeover after automatic detection of the number of power amplifiers, i.e. the number of speakers. Also, although the mixing control circuit 20 distinguishes between a full set and stereo set by the voltage of the SinM terminal, it could be arranged for the mixing control circuit 20 to be provided with a register in which data for distinguishing these is written.

Also, while it may be envisioned that the audio mixing circuit 2 could be substituted by DSP, since DSP is expensive, costs could be lowered by this audio mixing circuit 2 constructed by comparatively simple analog circuits. Also, the audio apparatus can be reduced in cost and reduced in size by forming the audio mixing circuit 2 and the audio signal conditioning circuit 3 in the form of a single chip on the same semiconductor substrate.

Also, the present invention is not restricted to the preferred embodiments described above and various design modifications are possible within the scope of the items set out in the claims. For example, although the above description was given for the case of a 5.1 channel audio apparatus 1, the present invention could of course be applied to a 6.1 channel or 7.1 channel audio apparatus in which even more audio sources (for example additional surround background sound) are provided.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-2. (canceled)

3. An audio apparatus comprising:
an audio mixing circuit that inputs a left channel audio signal, a right channel audio signal, a center channel audio signal, a surround left channel audio signal, a surround right channel audio signal and a sub-woofer channel audio signal and that is arranged to deliver output by respectively mixing a center channel audio signal, a surround left channel audio signal, and a sub-woofer channel audio signal with a left channel audio signal in a predetermined ratio, a center channel audio signal, a surround right channel audio signal, and a sub-woofer channel audio signal with a right channel audio signal in a predetermined ratio;
an audio signal conditioning circuit that inputs the output signal of the audio mixing circuit and adjusts the signal waveforms;
a power amplifier section including a plurality of power amplifiers that amplify audio signals whose signal waveform has been adjusted; and
a speaker section including a plurality of speakers driven by the amplified audio signals.

4. The audio apparatus according to claim 3, wherein said audio mixing circuit is arranged to select one of a condition in which output is delivered after mixing and a condition in which output is delivered without mixing the left channel audio signal, right channel audio signal, center channel audio signal, surround left channel audio signal, surround right channel audio signal, and sub-woofer channel audio signal.
